(19) United States
(12) Patent Application Publication
(10) Pub. No.: US 2026/0260501 A1
(43) Pub. Date: Sep. 3, 2026

(54) Device and Method for Detecting a Distraction of a Vehicle Driver

(71) Applicant: Bayerische Motoren Werke Aktiengesellschaft, Muenchen (DE)

(72) Inventors: Thomas Ewender, Muenchen (DE); Simone Camberg, Muenchen (DE); Johannes Feldmaier, Ebersberg (DE)

(21) Appl. No.: 18/995,715

(22) PCT Filed: May 12, 2023
(86) PCT No.: PCT/EP2023/062702

§ 371 Date: Jan. 16, 2025

(30) Foreign Application Priority Data
Aug. 8, 2022 (DE) 10 2022 119 855.3

(51) Int. Cl. G06V 20/59; G06V 10/82; G06V 20/52; G06V 40/18; G06V 40/20

(52) U.S. Cl. CPC G06V 20/597; G06V 10/82; G06V 20/52; G06V 40/18; G06V 40/28

(57) ABSTRACT

A device for detecting a distraction of a vehicle driver located on a driver seat of a vehicle includes at least one camera and at least on processing unit. The camera is supported by the vehicle, and is configured to capture at least one image having a depiction of an area of a vehicle interior comprising at least one arm of a vehicle driver and to generate image data corresponding to the image. The at least one processing unit is configured to process the image data, and to determine a position of the at least one arm of the vehicle driver and a hand position of a hand of the at least one arm based at least in part on the image data. The processing unit is further configured to check whether the determined hand position of the vehicle driver corresponds with a stored device position.

The present application is the U.S. national phase of PCT Application PCT/EP2023/062702 filed on May 12, 2023, which claims priority of German patent application No. 10 2022 119 855.3 filed Aug. 8, 2022, the entire contents of which are incorporated herein by reference.

### TECHNICAL FIELD

The disclosure relates to a device and a method for detecting a distraction of a vehicle driver located on a driver seat of a vehicle.

### BACKGROUND

Document DE 10 2020 165 A1 discloses a monitoring device for monitoring a vehicle driver of a motor vehicle and for checking whether a distraction of the vehicle driver exists according to a predetermined criterion due to an operating intention or already performed operating action. Document US 2018/0238686 A1 discloses a method for determining whether a vehicle driver mobile telephone or other portable electronic devices. Information determined with the aid of a camera is compared to information stored in a memory.

Document US 2021/0174103 discloses a vehicle driver monitoring system comprising at least two cameras. For this purpose, the pose of the vehicle driver in the recorded images based on images of the first and the second camera having the face of the vehicle driver can be used to detect a possible distraction of the vehicle driver.

Vehicle drivers often bring additional technical devices, such as smart phones and tablet computers, into a vehicle and arrange them at positions in the cockpit of the vehicle which are favorable from their viewpoint. Various mounts are available in the accessory market for arranging such devices. Such devices are also positioned at positions in the cockpit without additional mounts. During the operation of these devices by the vehicle driver, the driver is distracted. Systems are thus required by various lawmakers in the world which measure the degree of the attentiveness of a vehicle driver. In China, such systems are referred to as DAMS and apply to new vehicles from 2023. In Europe, such systems are called advanced driver distraction warning (ADDW) and apply to new vehicles from 2024.

Camera systems, which can be used simultaneously for driver monitoring and for interior monitoring, are used in the vehicle interior of vehicles to recognize the attentiveness of a vehicle driver. However, these interior cameras have a limited field of view, so that the additionally introduced devices are often not in the field of view of the camera. The hand of the vehicle driver is also then not visible or is only partially visible in the image recorded by the interior camera upon operation of these devices. Interior cameras in vehicles for driver monitoring typically have a field of view of at most 150°. A complex optical unit would have to be provided to enlarge this field of view, which requires a relatively large installation space and thus cannot be integrated into the cockpit without problems. Furthermore, relatively high costs are connected thereto. However, it is desirable to also detect interactions of the vehicle driver with devices as a distraction, which are located outside the field of view of the interior camera.

There is a need for a device and a method for detecting a distraction of a vehicle driver located on a driver seat of a vehicle due to devices or terminals additionally introduced into the vehicle.

### SUMMARY

The above-stated need, as well as others, are met by a device having the features discussed herein.

Due to at least some embodiments of the devices and methods disclosed herein, it is achieved that a distraction of the vehicle driver by a terminal introduced into the vehicle, such as a smart phone or a tablet computer, can be determined upon a correspondence of the device position and the hand position. In particular, a large number of possible device positions are stored, which are then all checked for correspondence with the determined hand position. Possible device positions are in particular charging trays installed in the vehicle, the area in front of an instrument cluster of the vehicle, the area in front of a central information display, the area in front of a head-up display, in or in front of storage compartments that can be folded open, on rubber mats in the cockpit, in front of the air outlet nozzles, for example, in the middle of the cockpit or on the left adjacent to the steering wheel, and possible arrangement positions of suction cup mounts, which are fastenable on the windshield of the vehicle and can have a so-called gooseneck. Furthermore, mounts are known which are fastenable on side windows. Other possible device positions are the cupholders in the vehicle and the area in front of the steering wheel.

Proceeding from the image data provided by the camera, the processing unit determines the position of an arm of the vehicle driver. In particular, the processing unit determines the position of the lower arm and preferably proceeding therefrom the position of the hand, even if it is not visible itself in the image. This can be carried out in particular with the aid of a human pose estimation method, by which the position of the lower arm can be determined as a 3D vector even from a 2D image, wherein proceeding therefrom the hand position is also determinable when it is not visible in the image. If the hand is visible in the image, the position of individual finger bones of the hand can also additionally be determined with the aid of known human pose estimation methods and movements of the fingers for operating terminals (tapping and swiping) can also be reliably detected. In known human pose estimation methods, 3D key points are extracted from a sequence of images of a video image stream, wherein the actual movement of the person is analyzed with the aid of the human pose estimation method and individual limbs of the person can be determined. In a typical movement analysis, known human pose estimation methods typically use 17 or 18 key points. In the present case, however, more or fewer key points can also be used in order to determine the position and movement of the arm of the vehicle driver.

It is particularly advantageous if the device positions of a large number of possible locations for arranging a terminal introduced into the vehicle are stored in the storage area of the processing unit. The processing unit then checks whether the determined hand position of the vehicle driver corresponds to one of the device positions. In this way, a large number of device positions can be taken into consideration when detecting the distraction of the vehicle driver.

Furthermore, it is advantageous if the processing unit is moreover designed to determine a course of the viewing direction of at least one eye of the vehicle driver proceeding from the image data and to check whether the viewing direction extends through the device position or one of the device positions. In this way, a further criterion for detecting the distraction of the vehicle driver is checked, which can be taken into consideration in the consideration of the decision as to whether distraction of the vehicle driver due to a terminal introduced into the vehicle actually exists.

Furthermore, the processing unit can determine the position of the arm of the vehicle driver proceeding from the image data with the aid of the human pose estimation method and, as already explained, determine the hand position proceeding from the position of the arm of the vehicle driver. Alternatively or additionally, the processing unit can determine the hand position proceeding from the image data with the aid of the human pose estimation method, even if the hand is located outside the recorded image, i.e. if the hand is located outside the field of view of the camera. It is particularly advantageous if the processing unit detects a distraction
if the hand position corresponds to the device position for a preset period of time, and/or
if the hand position corresponds multiple times to the device position within a preset period of time, and/or
if the hand position corresponds to the device position within a preset period of time and the viewing direction of the vehicle driver extends through the device position.

A relatively reliable detection of the distraction of the vehicle driver is possible in this way.

Furthermore, it is advantageous if the cockpit positions of an input or output unit of the vehicle, which is arranged in the device position or which is assigned preset to a device position or which is arranged at a distance of at most 5 cm from a device position, are stored in the storage area of the processing unit. In other embodiments, the cockpit positions of multiple input and/or output units of the vehicle are stored, which are located at or in the vicinity of a device position. The processing unit only detects the distraction if, in the period of time in which the hand position corresponds with the device position, the processing unit does not detect an operating input via the input units arranged at the cockpit position and/or if the processing unit determines that no warning messages are output via the output unit arranged at the cockpit position. A correct interaction of the vehicle driver with the vehicle being detected as a distraction by a terminal introduced into the vehicle is reliably avoided in this way.

It is particularly advantageous if the processing unit determines a movement of the arm and/or the hand of the vehicle driver proceeding from the image data of multiple images of an image sequence recorded in succession by the camera and determines an operation of a terminal introduced into the vehicle proceeding from known movement patterns. In this case, in particular typical movements during the operation of touchscreens of known terminals, such as tapping movements and swiping movements are determined by the arm movement and/or the hand movement. The processing unit preferably only determines an operation of a terminal introduced into the vehicle in the period of time in which the hand position corresponds with the device positions. Known movement patterns can be stored in the storage area of the processing unit. Alternatively or additionally, data of known movement patterns can be used for training an artificial neural network of the processing unit.

Furthermore, it is advantageous if the period of time is stored preset in the storage area of the processing unit and/or if a number of correspondences of hand position and device position determined within the preset period of time is preset as a target value in the storage area of the processing area, upon the exceeding of which the processing unit detects a distraction. In this way, i particular the probability that it is actually a distraction due to an introduced terminal is further increased. Furthermore, it is advantageous if the introduction of a terminal, such as a smart phone, at a known/suspicious position is also captured with the aid of the camera and detected by the processing unit. This can be taken into consideration by the processing unit as an additional decision feature in the determination of whether or not a distraction of the vehicle driver exists. In particular, the detection f the introduction of the terminal can be used as a first indication, in particular as a condition, in order to detect a distraction of the vehicle driver proceeding therefrom.

It is particularly advantageous if the processing unit detects the hand of the vehicle driver in the image proceeding from the image data of the image and carries out a tracking of the hand proceeding from further image data of multiple images of an image sequence recorded in succession by the camera and detects at which position designated as tracking. Proceeding from the following movement of the arm, the position of the hand in the vehicle interior is determined. The hand is preferably determined as a 3D vector, which is displaced in space with the arm proceeding from the movement of the arm.

It is particularly advantageous if the field of view of the camera has a capture angle in the range of 100° to 150°, wherein the camera only captures a part of the entire cockpit. The camera can in particular be a monocular camera for recording 2D images. This camera is preferably an IR-RGB camera or a monochromatic camera which records grayscale images, with or without infrared light capture, or a solely infrared camera.

A second aspect relates to a method having the features of the independent method claim, which can be refined in the same manner as the device as claimed in claim 1, in particular by the features of the dependent claims.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective schematic representation of a cockpit of a vehicle having an additional separate display unit; and

FIG. 2 shows a schematic image recorded by the interior camera having key points determined by a processing unit of the vehicle with the aid of a human pose estimation method.

### DETAILED DESCRIPTION

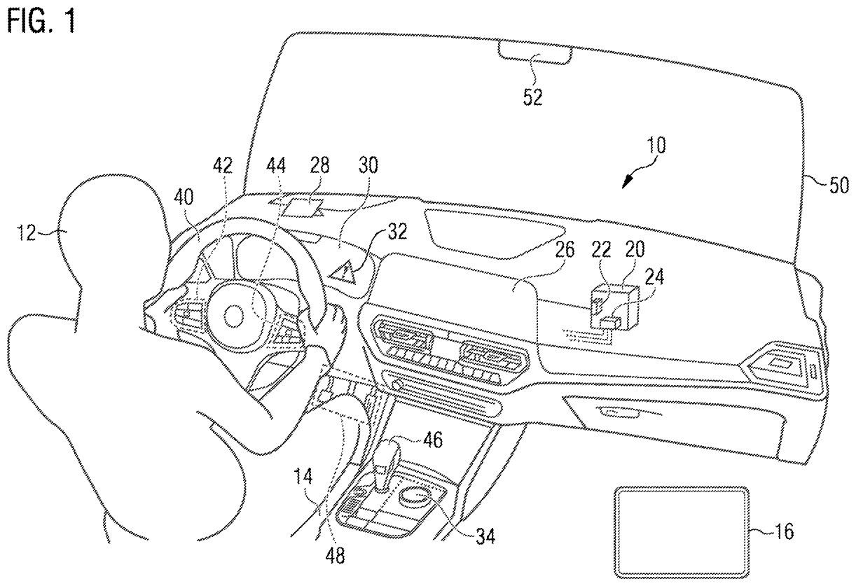

FIG. 1 shows a perspective schematic representation of a cockpit 10 of a vehicle. A vehicle driver 12 is seated on a on a driver seat 14 of the vehicle. A terminal in the form of a tablet computer 16 has been introduced into the vehicle and can be arranged at a more or less suitable point in the cockpit 10. A further terminal in the form of a smart phone 28 is arranged on the dashboard of the cockpit 10 in front of the steering wheel 40. In particular, such terminals 16, 18 are arranged in the cockpit 10 with the aid of mounts available in the accessory market so that the vehicle driver 12 can see and operate them. The vehicle driver 12 is distracted by the operation of these terminals 16, 28.

The cockpit 10 furthermore comprises a central information display (CID) 26, a head-up display, and a graphic instrument cluster 30, on which various display elements 32 and images can also be output. The cockpit 10 comprises a steering wheel 40 having operating elements 42, 44, a gear selector 46, a pedal system 48, and an input unit 34 having a rotating wheel and a pushbutton function and/or a touch input field. This input unit 34 is also referred to as an ergo commander.

An interior camera 52 for capturing at least one image having a depiction of an area of the interior of the vehicle is arranged in the upper area of a windshield 50 of the vehicle. The interior camera captures images having a depiction of at least a part of the upper body and the head of the vehicle driver 12. The interior camera 52 is used both for monitoring the attentiveness of the vehicle driver 12 and also for interior monitoring. The interior camera 52 generates image data corresponding to the image and transmits these data to a processing unit 20.

The processing unit 20 has data outputs 22 and data inputs 24, which are used for the connection to further units of the vehicle, in particular to further input and output units and control units of assistance systems.

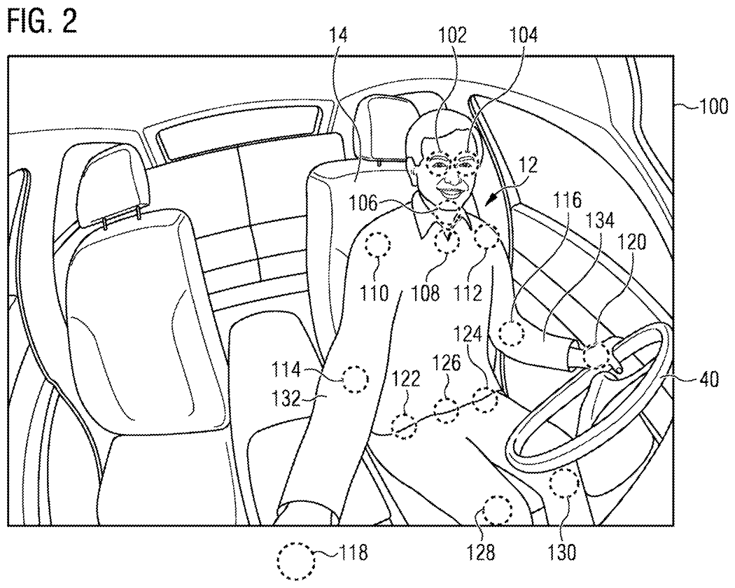

FIG. 2 shows a schematic image 100 recorded by the interior camera 52 having key points 102 to 130 determined by the processing unit 20 of the vehicle with the aid of a human pose estimation method.

The area camera 52 has a field of view of 120°. In other embodiments, the camera can also have a field of view in the range of 100° to 150°. The interior camera 52 is typically arranged and aligned in such a way that it does not acquire some areas of the cockpit 10, so that input devices 16, 20 which are introduced into the vehicle and arranged there are not located in the field of view of the interior camera 52 and therefore an operation of these terminals by the vehicle driver is not visible in the image. The device position of these introduced terminals 16, 28 is stored as a possible device position of introduced terminals in addition to further possible device positions of terminals in a storage area of the processing unit 20. These further positions can in particular be
charging trays provided in the vehicle,
the area in front of the instrument cluster 30,
in front of the central information display 26,
in or in front of storage compartments that can be folded open,
on rubberized surfaces present in the cockpit 10, in particular on rubber mats arranged in the cockpit
in front of the air outlet nozzles or ventilation grills in the cockpit 10 on the right and left in front of the vehicle driver 12,
typical positions of suction cup mounts, which can comprise a gooseneck and can typically be arranged on the right and left of the vehicle driver 12 on the windshield 50 or a side window,
mounts that can be clamped in side windows,
in cupholders, in front of the steering wheel 40 on the dashboard, and
other partially vehicle-specific device positions. All device positions coming into consideration for a vehicle are stored in the storage area of the processing unit 20, since the terminals 16, 28 can be arranged at each of these device positions. The processing unit 20 carries out a human pose estimation method, by which the key points 102 to 130 on the human body of the vehicle driver 12 are identified and classified. Proceeding from the image of the vehicle driver 12 recorded by the interior camera 52, the following key points were determined with the aid of the human pose estimation method:
   the right eye 102, the left eye 104, the base of the neck 106, the upper torso 108, the right shoulder 110, the left shoulder 112, the right elbow 114, the left elbow 116, the right hand 118, the left hand 120, the right hip 122, the left hip 124, the lower torso 126, the right knee 128, and the left knee 130.

Proceeding from these key points 102 to 130, the vectors between the key points 102 to 130 can be determined and tracked during a movement, in particular of the right arm 132 or the left arm 134 of the vehicle driver 12. It is thus also possible to determine the position of the hand outside the image 100 in the interior of the vehicle as the hand position 118.

In addition, methods are known by which the viewing direction of the eyes 102, 104 of the vehicle driver 12 is exactly determinable, so that the area of the cockpit 10 is determinable on which the view the vehicle driver 12 is directed. If the hand position 118 is located at a device position and/or the view is directed for a specific period of time onto a device position, it can thus be detected that the vehicle driver 12 is distracted and an introduced terminal is located at the device position. In addition, it can be checked whether an input and/or output unit, such as the central information display 26 or the instrument cluster 30, is located at the potential device position, a message 32 is output, which can draw the attention of the vehicle driver to it, or whether an input takes place via a corresponding input unit at the potential device position or in a surrounding region of at most 5 cm. In this case, the processing unit 20 does not detect the presence of a distraction of the vehicle driver by an introduced terminal, but rather detects a typical operating action in the vehicle.

The interior camera 52 progressively records images as an image sequence, i.e. a video sequence. In this way, movements of the arms 132, 164 of the vehicle driver 12 can be captured, from which hand movements can be concluded. Proceeding therefrom, operating inputs at a terminal possibly arranged at a device position, such as scrolling and tapping with index fingers or thumbs, can be detected. Due to the feedback from input devices, such as the central information display 26, to the processing unit 20, the processing unit 20 can easily carry out a distinction arranged at a device position from the correct vehicle operation. In particular, the operation of a climate control operating unit or an audio operating unit can be established by the processing unit 20 and taken into consideration accordingly in the detection of a distraction. An interaction with an introduced terminal can thus be distinguished easily from the interaction with vehicle operating elements. In the event of a detected distraction by a terminal, in accordance with the legal requirements, a warning or a notification can be output or corresponding information can be given to assistance systems, which, for example, enhances the degree of autonomous driving of the vehicle, increases the distance to other vehicles, reduces the speed, and/or pre-activates braking systems.

Multiple examples of the detection of a distraction of the vehicle driver 12 are described hereinafter.

### Example 1

The interior camera 52 captures images of the interior including parts of the body of the vehicle driver 12 and parts of the interior. The vehicle driver 12 looks at a smart phone, without the smart phone being in the field of view of the interior camera 52, for example, the smart phone is arranged on a mount on the ventilation grill of an air outlet in the middle of the cockpit 10, i.e. on the right in front of the vehicle driver 12 from the viewpoint of the vehicle driver 12.

The processing unit 20 processes the image data of the images captured with the aid of the interior camera 52 and increasingly detects looks in the direction of the ventilation grill. For this purpose, the processing unit 20 captures the number of the looks of the vehicle driver 12 within a preset time in the range of 5 seconds to 60 seconds and/or accumulates the time of the looks of the vehicle driver 12 at the area of the ventilation grill. The ventilation grill or the area in front of the ventilation grills is stored as a possible device position in the processing unit 20.

The processing unit 20 does not capture any interaction with operating elements in the area, such as a hazard light button, which is arranged in the area of the ventilation grill, in the period of time of the increased looks. The output of warning messages on output units in this area is also monitored by the processing unit 20, since such messages would also establish an explanation for the look of the vehicle driver 12 in the direction of the device position in front of the ventilation grills.

If a preset threshold value is exceeded, the processing unit 20 can classify that the vehicle driver 12 interacts with the smart phone. A period of time in which increased looks are permissible and then a distraction is detected if this threshold value is exceeded can be preset as a threshold value. Alternatively or additionally, the number of the looks in a preset period of time and/or the accumulated look duration in a preset period of time can also be captured and compared to a target value. If the target value is exceeded, the processing unit 20 detects a distraction of the vehicle driver 12. Therefore, an expansion of the evaluation algorithms of the processing unit 20 for recognizing a smart phone interaction by the vehicle driver 12 when the smart phone is not visible in the image 100 recorded with the aid of the interior camera 52, i.e. when the smart phone is located outside the field of view of the interior camera 52, is carried out according to the disclosure.

### Example 2

The vehicle driver 12 looks at the smart phone without the smart phone being arranged in the field of view of the interior camera 52. For example, the smart phone is arranged in the area in front of the air outlet nozzles or ventilation grills in the cockpit 10 as in example 1. With the aid of progressively recorded camera images, the movement of the arm 130 of the vehicle driver 12 or, if the fingers of the right arm 130 of the vehicle driver 12 are visible in the image 100, the movement of the fingers is captured and evaluated with the aid of a human pose estimation method, in order to conclude an operation of a terminal or smart phone from the movement of the arm 132, 134 and/or the fingers. In addition, the processing unit 20 captures an increased number of looks in the direction of the ventilation grill proceeding from the images captured by the interior camera 52. The processing unit 20 recognizes a movement of the arm 130 and the hand 118 away from the steering wheel 40 with outstretched fingers of the hand in the direction of the ventilation grill, before the fingers and the hand disappear from the field of view of the interior camera 52 due to the movement of the hand in the direction of the ventilation grill.

The processing does not capture any operating actions or interaction with input and output units in this area of the cockpit 10, which would make a look and a movement of the hand in this area necessary.

If the processing unit 20 determines that a threshold value is exceeded, the processing unit classifies that the vehicle driver 12 interacts with the smart phone, i.e. the processing unit 20 detects that the vehicle driver 12 is distracted. Reference is made to example 1 for the statements on the threshold value and for further options for establishing that the vehicle driver 12 interacts with the smart phone or that a distraction of the driver 12 exists.

### Example 3

In the same manner as in example 1 and example 2, the vehicle driver 12 interacts with a smart phone, wherein movements with the fingers and/or arms of the vehicle driver 12 are visible in the images 100, but the smart phone is not arranged in the field of view of the interior camera 52. It can be arranged in front of the air outlet nozzles or ventilation grills in the middle of the cockpit 10 in the same manner as in example 1 and example 2.

Proceeding from the images 100 progressively captured with the aid of the interior camera 52, the image data of which are processed by the processing unit 20, the processing unit 20 captures a movement of the hand or the key point 118 of the vehicle driver 12 with outstretched fingers in the direction of the air outlet nozzles (not visible in the image 100).

Furthermore, the processing unit 20 does not detect operating actions of operating elements in this area, such as button actuations or output of warning messages, which would make a movement of the hand or a viewing direction toward this potential device position of the smart phone necessary. A secure detection of the distraction of the vehicle driver 12 is possible in particular by the determination of the hand movement and/or the outstretched fingers, before the hand leaves the field of view of the interior camera 52.

In principle, it is possible with the aid of a human pose estimation method to extrapolate the position of key points 102 to 130, such as the position of a hand 118 or the position of fingers, which are no longer visible in an image of a person. By determining the vectors between the individual key points, 3D vectors of limbs of a person and the 3D position of the key points 102 to 130 can be determined. It is thus possible to determine both the position of a hand and the position of a fingertip, even if this body part is no longer visible in the image 100. As a time threshold value, a distraction can be detected when the hand position and the device position last longer than a preset time, wherein the present time has a value in the range of 0.5 seconds to 5 seconds, in particular a value of 1 second.

Operating inputs, such as tapping or swiping, are possible with the aid of a gesture recognition method proceeding from a movement of the arm 130 even if the hand executing the operating input or the fingers of the hand executing the operating input are not visible in the captured image 100.

As a further possible measure after the detection of a distraction, threshold values can be adapted, in particular of assistance systems. Additionally or alternatively, graphic or acoustic warning notices can also be output to the vehicle driver 12.

### LIST OF REFERENCE SIGNS

10 cockpit
12 vehicle driver
14 driver seat
16 tablet computer
20 control unit
22 data output
24 data input
26 central information display
28 smart phone
30 instrument cluster
32 display element
34 ergo commander
40 steering wheel
42, 44 operating elements
46 gear selector
48 pedal system
50 windshield
52 interior camera
100 camera image
102 to 130 key points
132, 134 arm of the vehicle driver

1.-11. (canceled)

12. A device for detecting a distraction of a vehicle driver located on a driver seat of a vehicle, comprising:
at least one camera supported by the vehicle, the at least one camera configured to capture at least one image having a depiction of an area of a vehicle interior comprising at least one arm of a vehicle driver and to generate image data corresponding to the image,
at least one processing unit configured to process the image data,
wherein the processing unit is further configured to determine a position of the at least one arm of the vehicle driver and a hand position of a hand of the at least one arm based at least in part on the image data,
wherein at least one device position of a possible location for arranging a terminal introduced into the vehicle in a cockpit of the vehicle is stored in a storage area of the processing unit, and
wherein the processing unit is further configured to check whether the determined hand position of the vehicle driver corresponds with the device position.

13. The device as claimed in claim 12, wherein:
device positions of a large number of possible locations are stored in the storage area of the processing unit, and
the processing unit is further configured to check whether the determined hand position of the vehicle driver corresponds with more than one of the device positions.

14. The device as claimed in claim 13, wherein the processing unit is further configured to:
determine a course of a viewing direction of at least one eye of the vehicle driver based at least in part on the image data, and
check whether the viewing direction extends through one or more of the device positions.

15. The device as claimed in claim 12, wherein the processing unit is further configured to:
determine a course of a viewing direction of at least one eye of the vehicle driver based at least in part on the image data, and
check whether the viewing direction extends through the device position.

16. The device as claimed in claim 15, wherein the processing unit is configured to:
detect a distraction if the hand position corresponds with the device position within a preset period of time and the viewing direction of the vehicle driver extends through the device position.

17. The device as claimed in claim 12, wherein the processing unit is configured to:
determine the position of the at least one arm based at least in part on the image data using a human pose estimation method, and
determine the hand position based at least in part on the position of the at least one arm of the vehicle driver.

18. The device as claimed in claim 12, wherein the processing unit is configured to:
determine the position of the at least one arm based at least in part on the image data using a human pose estimation method, and
determine the hand position based at least in part on the image data using the human pose estimation method, determines the hand position.

19. The device as claimed in claim 12, wherein the processing unit is configured to:
detect a distraction if the hand position corresponds multiple times with the device position within a preset period of time.

20. The device as claimed in claim 19, wherein
a number of the hand position and device position corresponding multiple times within the preset period of time is preset as a target value in the storage area of the processing unit, whereupon exceeding the target value the processing unit detects a distraction.

21. The device as claimed in claim 12, wherein the processing unit is configured to:
detect a distraction if the hand position corresponds with the device position for a preset period of time.

22. The device as claimed in claim 21, wherein, in the storage area of the processing unit, a cockpit position of at least one input and/or output unit of the vehicle is stored, which is arranged at the device position or which is arranged at a distance of up to 5 cm from the device position or which is associated in a preset manner with a device position, and
wherein the processing unit is configured to only detect the distraction if, in a period of time in which the hand position corresponds with the device position, the processing unit does not detect operating inputs via the input unit arranged at the cockpit position.

23. The device as claimed in claim 21, wherein, in the storage area of the processing unit, a cockpit position of at least one input and/or output unit of the vehicle is stored, which is arranged at the device position or which is arranged at a distance of up to 5 cm from the device position or which is associated in a preset manner with a device position, and
wherein the processing unit is configured to only detect the distraction if, the processing unit determines that no warning message is output via the at least one output unit arranged at the cockpit position.

24. The device as claimed in claim 21, wherein the processing unit is configured to:
use image data of multiple images recorded in succession by the camera to determine an image sequence of a movement of at least one of group consisting of the arm and the hand of the vehicle driver,
determine an operation of a terminal introduced into the vehicle based on known movement patterns,
wherein the processing unit only detects the distraction when the processing unit determines the operation of the terminal introduced into the vehicle in the period of time in which the hand position corresponds with the device position.

25. The device as claimed in claim 24, wherein the known movement patterns are in stored in the storage area of the processing unit and/or are used for training an artificial neural network of the processing unit.

26. The device as claimed in claim 20, wherein at the period of time is stored preset in the storage area of the processing unit.

27. The device as claimed in claim 12, wherein the processing unit is configured to, based at least in part on the image data of the image, detects the hand of the vehicle driver in the image and, based at least in part on further image data of multiple images of an image sequence recorded in succession by the camera, carries out tracking of the hand and detects at which position the hand leaves the image and, based at least in part on following movement of the arm, determines the hand position in the vehicle interior.

28. The device as claimed in claim 12, wherein, a field of view of the camera has a capture angle in a range of 100° to 150°, wherein the camera only captures a part of the cockpit.

29. The device as claimed in claim 28, wherein the camera is at least one of the group consisting of a monocular camera and an RGB camera.

30. A method for detecting a distraction of a vehicle driver located on a driver seat of a vehicle, comprising:
capturing at least one image having a depiction of an area of a vehicle interior comprising at least an upper body of a vehicle driver and generating and processing image data corresponding to the image using a processing unit,
wherein, based at least in part on the image data, a position of at least one arm of the vehicle driver is ascertained and, based on the position of the at least one arm, a hand position of a hand of the vehicle driver is ascertained,
wherein at least one position of a possible location for arranging a terminal introduced into the vehicle in a cockpit is stored as a device position in a storage area of the processing unit,
wherein it is determined whether the determined hand position of the vehicle driver corresponds with a device position of a possible location for arranging a terminal introduced into the vehicle in the cockpit.
